(19) United States
(12) Patent Application Publication
(10) Pub. No.: US 2013/0116809 A1
(43) Pub. Date: May 9, 2013

(54) TOURNAMENT GAME, GAMING MACHINE, GAMING SYSTEM, AND METHOD WITH TEAM MANAGEMENT

(71) Applicant: Multimedia Games, Inc., Austin, TX (US)

(72) Inventors: John Jordan Carpenter, Austin, TX (US); Loren Jacobs, Austin, TX (US)

(73) Assignee: Multimedia Games, Inc., Austin, TX (US)

(21) Appl. No.: 13/622,301

(22) Filed: Sep. 18, 2012

Related U.S. Application Data
(63) Continuation-in-part of application No. 13/239,171, filed on Sep. 21, 2011.
(60) Provisional application No. 61/541,752, filed on Sep. 30, 2011.
(60) Provisional application No. 61/388,598, filed on Sep. 30, 2010.
(60) Provisional application No. 61/406,019, filed on Oct. 22, 2010.

(51) Int. Cl. G06F 19/00

(52) U.S. Cl. 700/92

(57) ABSTRACT

A tournament game, gaming machine, gaming system and method are disclosed wherein a tournament management interface allows operators to organize their slot tournament players into teams and manage the advancement of those teams with a variety of templates throughout the tournament.

### CROSS-REFERENCE TO RELATED APPLICATIONS

This application is a continuation-in-part of U.S. patent application No. 13/239,171, filed Sep. 21, 2011, entitled “Tournament Game, Gaming Machine, Gaming System And Method With A Player-Interactive Bonus Feature,” claiming the benefit, under 35 U.S.C. §119(e), of U.S. Provisional Patent Application No. 61/388,598 filed Sep. 30, 2010, having the same title, and of U.S. Provisional Patent Application No. 61/406,019 filed Oct. 22, 2010, also having the same title.

The Applicants claim the benefit, under 35 U.S.C. §120, of U.S. patent application No. 13/239,171, filed September 21, 2011, and also claim the benefit, under 35 U.S.C. §119(e), of U.S. Provisional Patent Application No. 61/388,598, filed Sep. 30, 2010, and of U.S. Provisional Patent Application No. 61/406,019, filed Oct. 22, 2010, and of U.S. Provisional Patent Application No. 61/541,752, filed Sep. 30, 2011 and entitled “Tournament Game, Gaming Machine, Gaming System And Method With Improved Team Management.” The entire content of each of these prior nonprovisional and provisional applications is incorporated herein by this reference.

### COPYRIGHT NOTICE

A portion of the disclosure of this patent document contains material which is subject to copyright protection. The copyright owner has no objection to the facsimile reproduction of the patent document or the patent disclosure as it appears in the U.S. Patent and Trademark Office patent files or records but otherwise reserves all rights of copyright whatsoever.

### FIELD OF THE INVENTION

This invention relates to wagering games, gaming machines, gaming systems, and associated methods. More particularly, the invention relates to convertible in-revenue and out-of-revenue gaming machines, systems and related methods which provide tournament features with improvements to managing player tournament participation in teams.

### BACKGROUND

Various gaming systems have been developed to provide dedicated in-revenue and out-of-revenue gaming. An example of in-revenue operation is a gaming machine or system in which game play is initiated with a money (or equivalent) wager by a player. An example of out-of-revenue operation is a gaming machine or system in which game play doesn't require a wager (e.g. tournament or free play).

With typical past tournament systems, casino operators have had to manually manage the advancement of team tournaments via spreadsheets or other manual 3^{rd} party applications. This required the operator to manually setup each team, track them individually, and update their positions throughout the slot tournament. This manual process increased the amount of time tournaments took to setup, run, and obtain reporting plus increased the number of human errors and paperwork associated with configuring manual team tournaments.

The team tournament features herein eliminates or minimizes problems associated with setting up and configuring manual team tournaments. With current team tournaments, players have difficulty telling what team they are on, who their teammates are, or what place their team is until sometime after the end of the tournament. How long they wait is dependent on how quickly the operator can manually, with a spreadsheet, crunch the numbers on what team(s) has accumulated the most points or has achieved the highest ranking and has won the tournament.

There continues to be a need for innovative methods and gaming systems which provide convertibility between in-revenue and out-of-revenue gaming operation. There is also a need for innovative methods and systems for presenting tournament games and especially team tournament games, in different ways to generate player interest and excitement.

### SUMMARY OF THE INVENTION

The team tournament feature of the present tournament system allows operators to organize their slot tournament players into teams and manage the advancement of those teams with a variety of templates throughout the tournament right on the tournament system user interface, thus eliminating the manual steps noted above.

One advantage of the present team tournament feature is that it gives operators an easy and efficient way to run team tournaments without the hassle of manually exporting player data to spreadsheets and other third party applications in order to determine which players or teams will advance to subsequent rounds or win a tournament. It also gives operators multiple ways to setup team tournaments thus allowing them to automate how they currently run their manual team tournaments. This automation makes the entire process more efficient and allows them to be able to run their tournaments faster and get their games back into revenue.

Throughout the tournament, the team position and score is constantly displayed to players and spectators watching the tournament on the individual electronic gaming machines (EGMs), and overhead signs. This information is shown in real time and is an efficient way for players to see all tournament info without taking their eyes off the main game screen.

Throughout the tournament the individual picture in picture screens on all EGMs display the team current point leaders with an actual live video feed of them playing, their name and their current position. At the conclusion of the tournament, the PIP feed of each player on the winning team is displayed on the overhead sign and each individual EGM.

The team tournament feature performs score calculation and ranking in real time through a common interface, and the operator has the ability to export report(s) or print immediately, during or after completion of each tournament.

### BRIEF DESCRIPTION OF THE DRAWINGS

FIG. 1 illustrates an example convertible in-revenue and out-of-revenue game system shown with a control center server controlling a bank of gaming machines with respective game themes, such as during an in-revenue gaming operating mode, in accordance with one or more embodiments.

FIG. 2 illustrates an example convertible in-revenue and out-of-revenue gaming system with a bank of gaming machines with respective game themes, such as during an in-revenue gaming operating mode, and a connected overhead display showing an example tournament advertising banner in accordance with one or more embodiments.

FIG. 3A is a side view of an example convertible in-revenue and out-of-revenue gaming system with two back-to-back banks of gaming machines with respective game themes, such as during an in-revenue gaming operating mode, and a connected overhead display in accordance with one or more embodiments.

FIG. 3B is a front view of an example convertible in-revenue and out-of-revenue gaming system shown in FIG. 3A with the overhead display showing an example game theme advertising banner for the JAMBALAYA JACKPOT® game in accordance with one or more embodiments.

FIG. 4A illustrates an example front view of a convertible gaming machine with a camera and a secondary display with an example tournament advertising banner in accordance with one or more embodiments.

FIG. 4B illustrates an example logical layout of a convertible gaming machine in accordance with one or more embodiments.

FIG. 5 illustrates an example bank of gaming machines in out-of-revenue mode and with an overhead display showing an example real-time team tournament leaderboard and player video feed in accordance with one or more embodiments.

FIG. 6A is a flow chart of a process for setting up a new team tournament according to one embodiment.

FIG. 6B is a screenshot diagram of an example tournament setup interface according to the embodiment of FIG. 6A.

FIG. 6C is a screenshot diagram of an example tournament setup interface occurring after that shown in FIG. 6B.

FIG. 7A is a flow chart of a team tournament registration process according to one embodiment.

FIG. 7B is a flow chart of an alternative embodiment of an automated team tournament registration process.

FIG. 8 is a screenshot diagram of an operator team tournament control interface according to one embodiment.

FIG. 9 is a flow chart of a process of conducting a team tournament according to one embodiment.

FIG. 10A is a screenshot diagram of an example team leaderboard 601 according to one embodiment.

FIG. 10B is a screen diagram of an example team leaderboard 601 according to another embodiment.

FIG. 10C is a screen diagram of a team video feed 603 according to another embodiment.

FIG. 11 is a screenshot of two adjacent gaming cabinets showing team leaderboard displays for different teams.

FIG. 12 is a diagram of a game screen feature in which a player video is shown with an indication of the player's team.

### DESCRIPTION OF ILLUSTRATIVE EMBODIMENTS

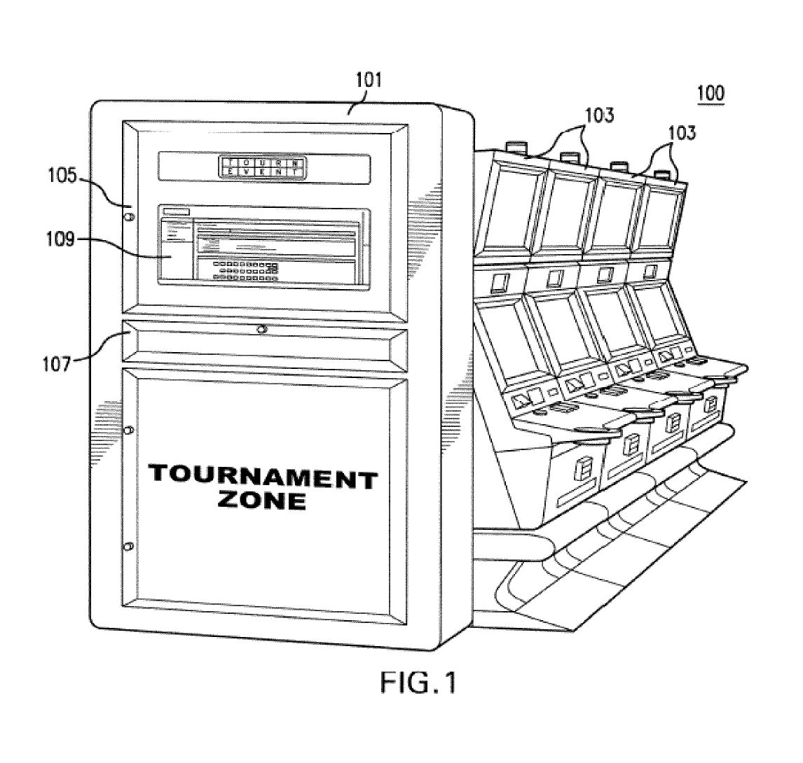

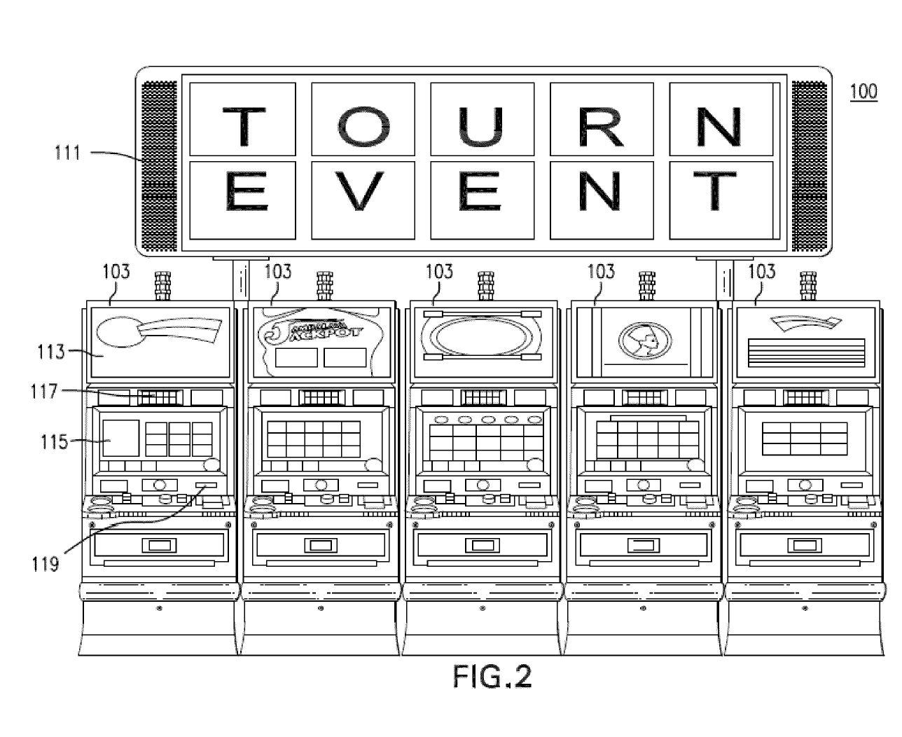

Referring to FIG. 1 and also to FIGS. 2-4, example server-based convertible in-revenue and out-of-revenue gaming system 100 is shown with control center server 101 enabling remote functionality management of a number of gaming machines 103, such as updating game configuration, uploading advertisements, administering tournaments, and converting in-revenue and out-of-revenue operation, in accordance with one or more embodiments. Control center server 101 includes a user console secured by key-locked cabinet doors 105 and 107. The user console includes display 109 and a conventional keyboard and mouse (not shown). Display 109 is visible through a window of door 105. Door 107 opens about a horizontally disposed hinge or hinges situated at the lower portion of the door so that it may swing downward. Behind door 107, a recessed slideable tray may support the keyboard and mouse and slide outward approximately six to eight inches to accommodate user (such as a casino operator) access to the keyboard and mouse. The keyboard, mouse, and display 109 connect to the server which may be a conventional personal computer motherboard or server grade hardware with ports to support the peripherals along with network connections and memory, such as a hard drive, PROM or CD ROM, containing the programming to support the server controlling in-revenue and out-of-revenue operating modes of gaming machines 103 and to support creation, editing, and storing of command, instruction, and data sets associated with in-revenue and/or out-of-revenue events. The installed software may include a Microsoft Windows® OS, enabling menu driven document creation and editing to provide user-friendly document/program search or creation, editing, storage, and execution functionality within the limits of the user's authorization level. User authorization and access may be accommodated through an initial username and password entry screen. Once a user's authorization has been verified through matching with records stored on the server or network, a main menu may be displayed enabling a user to access, initiate or program out-of-revenue or in-revenue events.

As will be discussed further below, control center server 101 may be programmed to implement several different controllers providing functions or services for the gaming machines 103 and associated equipment (such as the overhead display 111 described below). In particular, control center server 101 may implement a tournament controller for controlling and facilitating the conversion of gaming machines 103 from individual in-revenue play to tournament play (either in-revenue or out-of-revenue) and back. During tournament play, the tournament controller communicates with the various gaming machines 103 participating in the tournament, maintains information on the conduct of the tournament, such as real-time standings and scores, and makes tournament information available to the gaming machines 103 or other system elements for display over the course of the tournament. In its operation as a tournament controller, control center server 101 also controls the conversion of gaming machines 103 back from tournament play mode to individual play mode.

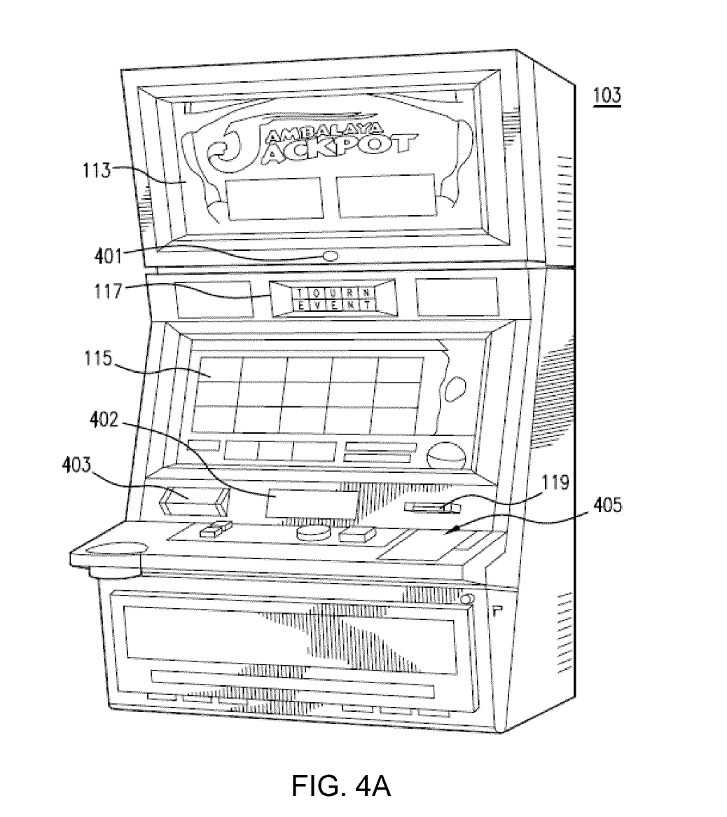

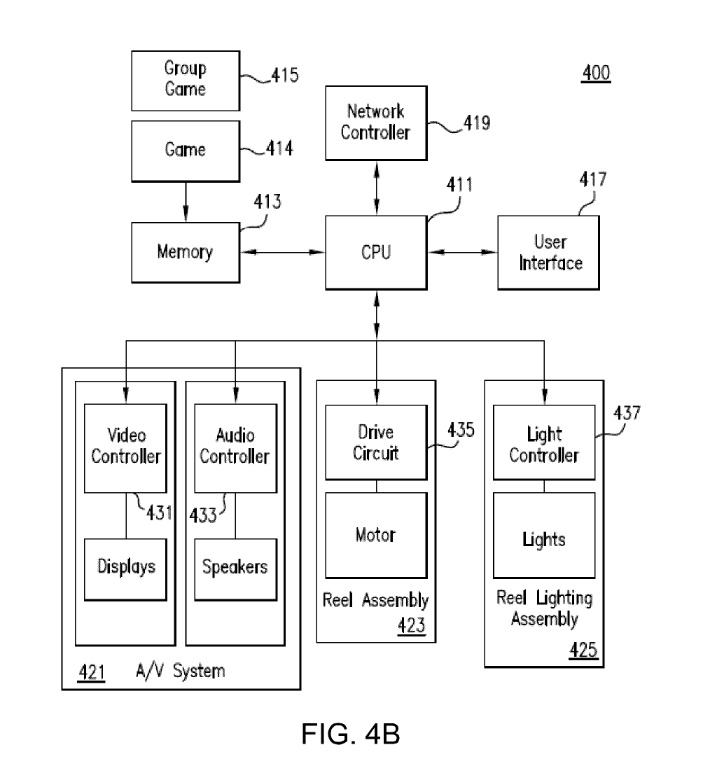

During in-revenue operational mode, gaming machine 103 may operate conventionally wherein a player may: a) enter currency, such as through a bill acceptor 403 in FIG. 4A, b) initiate a wager by selecting one or more lines and one or more credits per line, such as by respectively pressing the lines and credits buttons on a button deck 405 in FIG. 4A, and c) initiate play of the game displayed on display 115 by pressing the play, repeat bet, or max bet button on button deck 405. In-revenue operation may be performed through Class II or Class III gaming machines.

Class II gaming machines include bingo-based, lottery and/or central determination gaming machines; for example, a player may initiate a game at a Class II gaming machine, a processor for the gaming machine may send a request for a game outcome which may be transmitted to the gaming machine from an external server (e.g. central determination server) based on a random determination, and a game presentation may be displayed by the gaming machine in accordance with the game outcome. Often Class II gaming systems include a network of connected gaming machines (player stations) and use a finite pool of outcomes wherein the pool of possible outcomes are reduced by one each time an outcome is selected from the pool.

Class III gaming machines may include a random or pseudo-random number generator operated by a processor which may be local or remote to the gaming machine. The processor may determine a game outcome using the random number generator and the gaming machine may display a game presentation in accordance with the determined game outcome.

In either Class II or III gaming machines or systems, the player may be paid an award by the gaming machine or gaming system in accordance with the determined game outcome and a paytable which may be stored on the gaming machine or may be accessible by the gaming machine.

Conversion of a selected set of gaming machines 103 connected to control center server 101 may be programmed to occur at one or more selected times during any period of time, e.g. a day, week, month, as may be elected by a user (operator). In accordance with programming as tournament controller, control center server 101 may transmit instructions to the selected set of gaming machines 103 concerning an impending conversion and subsequently to initiate a conversion from in-revenue operating mode for individual play to a competition operating mode for group play. The programming may be initiated automatically according to a schedule or may be initiated manually by a user. In one or more embodiments, control center server 101 may be programmed to transmit an impending conversion instruction or instructions to the selected set of gaming machines at a selected period of time or times prior to the conversion, such as 15, 10, 5, and/or 1 minute. For example, control center server 101 may instruct each gaming machine 103 to display a fifteen minute warning, ten minute warning, five minute warning, and then display a sixty second countdown. Control center server 101 may further instruct each gaming machine 103 to disable additional in-revenue play following the completion of the countdown and following completion of any current game play to automatically cash out the credit meter of any associated gaming machine 103. Following cash out, control center server 101 functioning as tournament controller may transmit instructions to each of the gaming machines 103 to display respectively associated players' names and to install the competition game for the group play session being initiated.

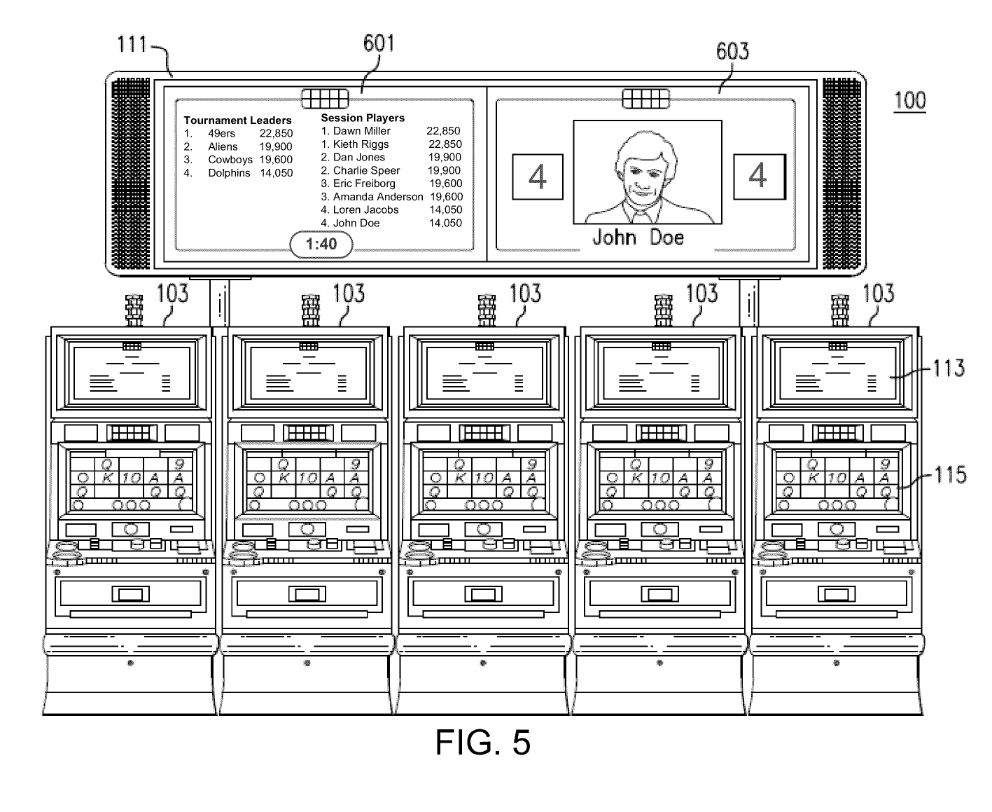

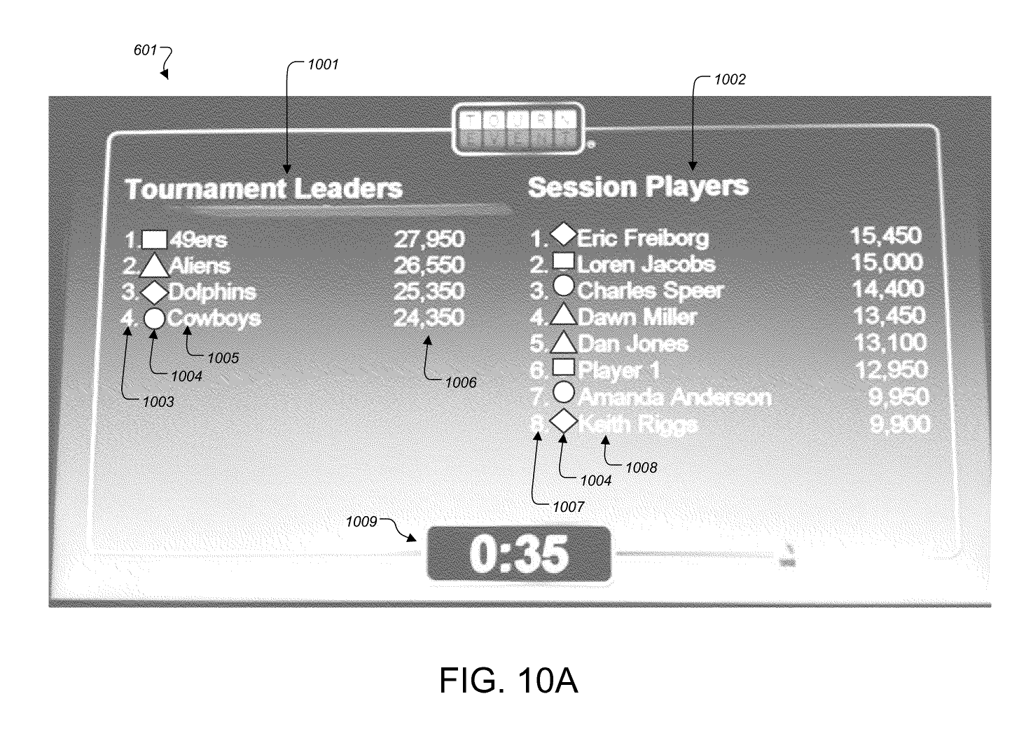

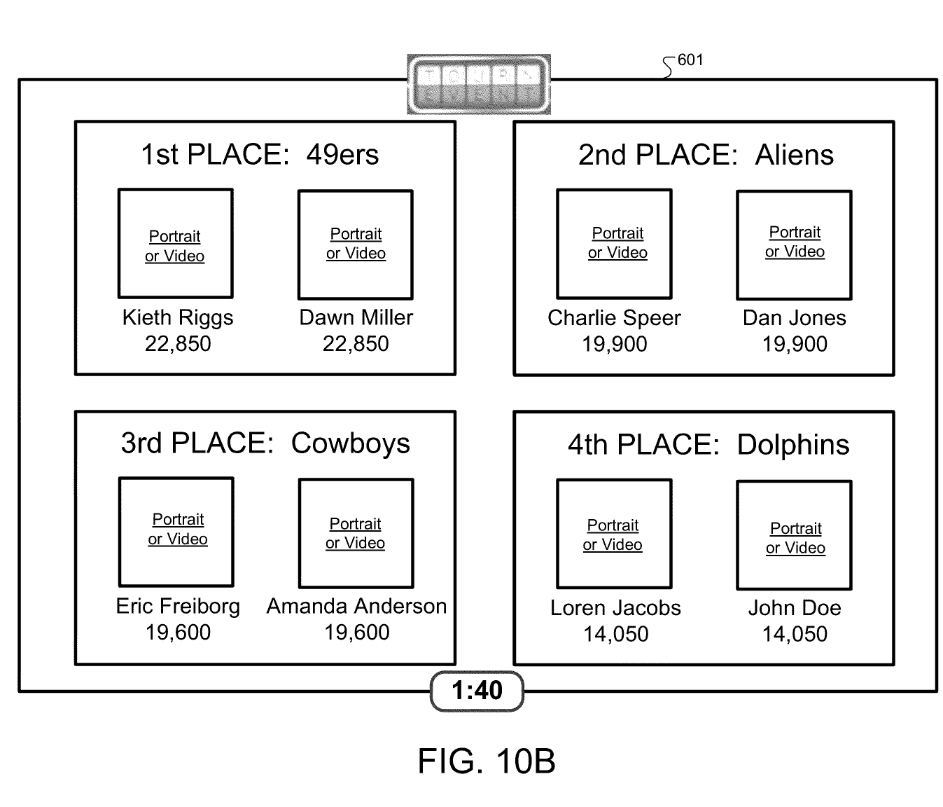

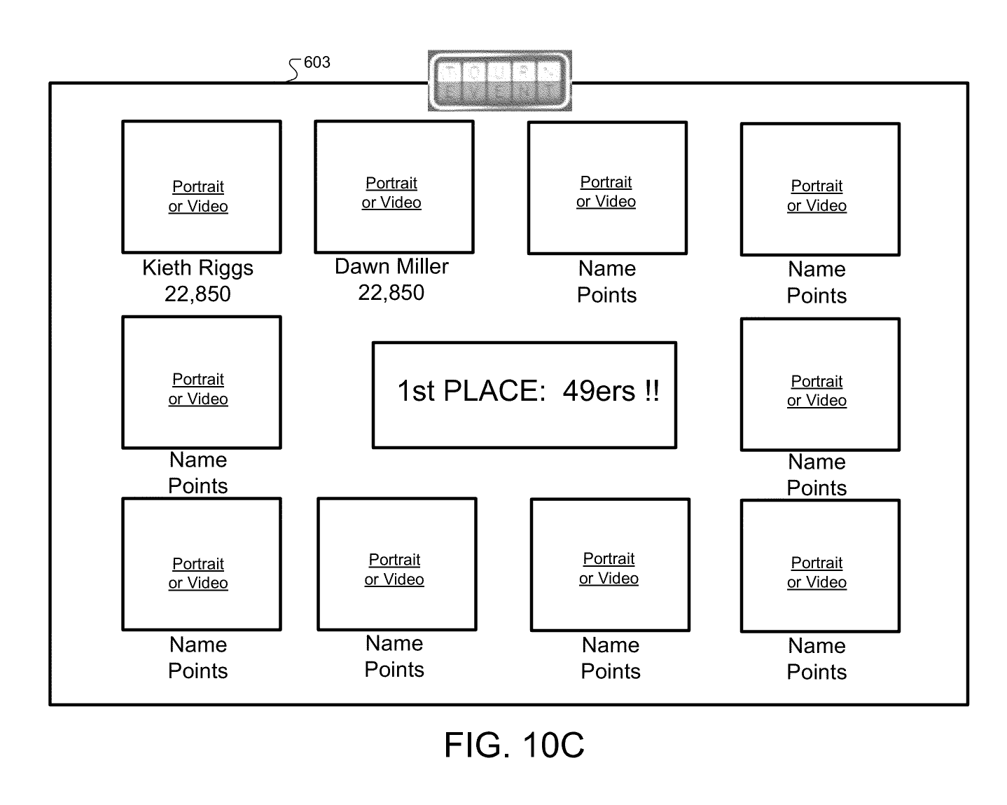

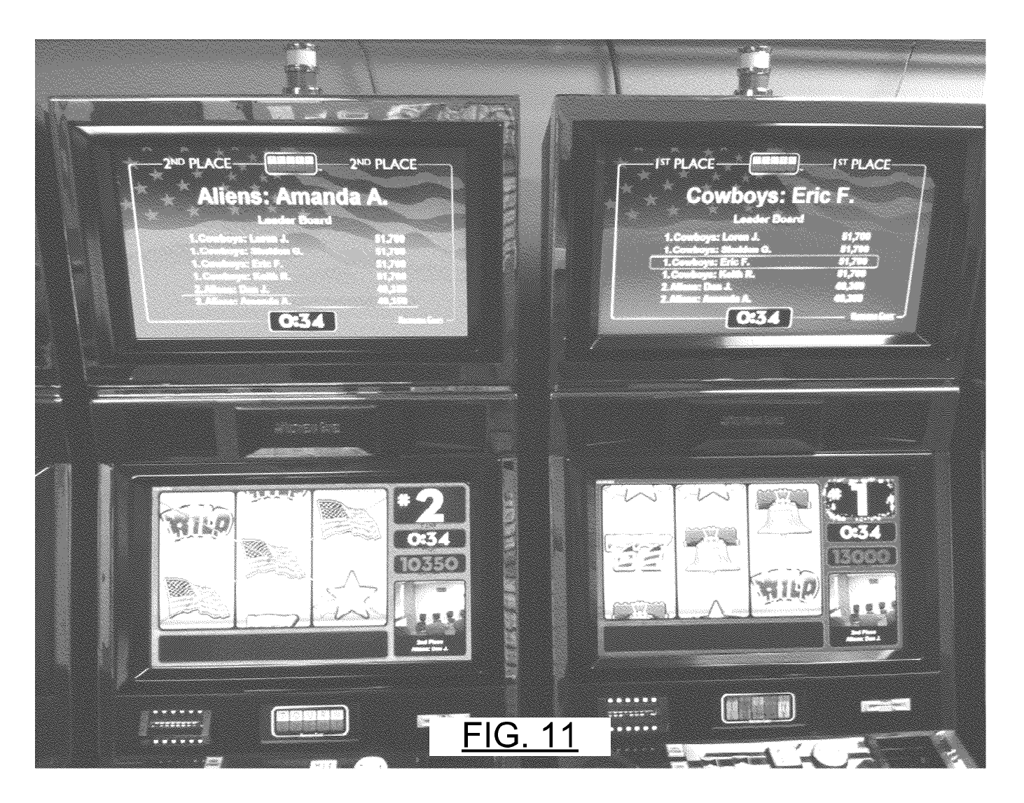

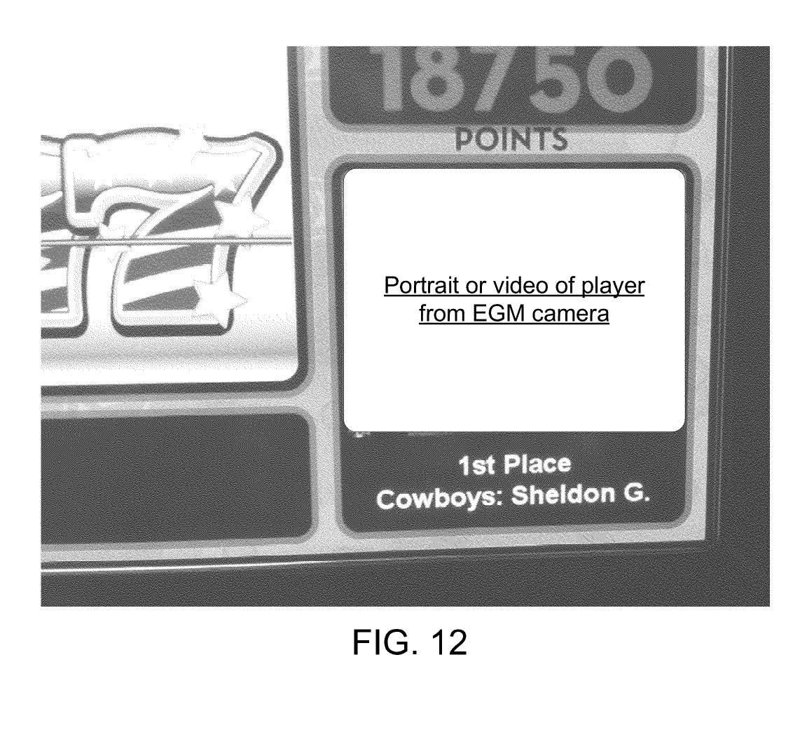

One example of an out-of-revenue operational mode may be a tournament event wherein a game having the same paytable and volatility is installed and operational on each of gaming machines 103. During a tournament event, each participating gaming machine 103 may be operated without funds, players may accumulate virtual points or dollars by playing a game on their respective gaming machine 103, and one or more winners may be identified based on the accumulated totals obtained during a predetermined period of time, which may correspond to a programmed or manually initiated definitive start and stop time or a predetermined number of plays. For example, an operator may initiate a tournament event by using a menu program with the console connected to control center server 101 and selecting the participating gaming machines, an amount of time for the tournament to play, and a begin tournament option. Alternatively, the predetermined period of time may comprise randomly triggered start and/or stop times, such as through a game event or through use of a random number generator. During the tournament event, each participating gaming machine may capture live streaming video of tournament contestants through respective cameras 401 (shown in FIG. 4A) and transfer the live video feed in accordance with programming to selected locations, such as overhead display 111 (FIG. 5 and others) or player dashboard (shown in FIGS. 11 and 12). When activated, camera 401 may capture real-time images of the player which may be transmitted directly (or indirectly through an intermediate processing device) to one or more displays in accordance with programming executed by the game processor and requests by control center server 101 (or another gaming machine 103 or remote device operating as the control center server). Throughout the tournament event, team leaderboard 601 shown in FIG. 5 may be displayed on a real-time basis to present tournament standings and live video feed 603 may be displayed to present player reactions on overhead display 111. During tournaments, the player's video may be displayed for a certain amount of time along with their current position. The video feed may then be switched so that overhead display 111 shows live video of another player participating in the tournament. As further described below, video of all teams in the tournament, or some subset such as the top five teams, may be serially displayed on overhead display 111. That is, video of the first place team is displayed for a time, then switched to the second place team, then the third place team and so forth, returning to video of the first place team upon completion of showing all of the designated subset of teams. Also, some implementations may cause the video displayed at overhead display 111 to be switched when there is a change in rankings of the teams in a tournament. For example, the video displayed at overhead display 111 may be switched to live video of the new first place team when a lower ranking team overtakes the leader to become the new first place team. At the completion of a tournament, the winner's video may be shown on overhead signs with a celebratory message. (See, for example, FIGS. 10B-C.) In one or more instances, a player may opt for anonymity while playing. In one or more embodiments, the player may select a player avatar from a set of available avatars and/or a pseudonym which may be displayed in place of a live video feed or picture when their team display appears.

Referring to FIG. 2, another embodiment of convertible in-revenue and out-of-revenue gaming system 100 is shown with a bank of gaming machines 103 with respective game themes, such as during an in-revenue gaming operating mode, and connected to overhead display 111 (showing an example tournament advertising banner) in accordance with one or more embodiments. Each of gaming machines 103 and overhead display 111 may be conventionally networked to coordinate gaming events and conversion between in-revenue and out-of-revenue operating modes. A networked conversion and controller unit may be an external server, such as control center server 101, a remote floor server, or a remote backend server, or, one of gaming machines 103 may be programmed to operate as a control center server. As shown by example in FIG. 2, gaming machines 103 may be configured as in-revenue and have various games being presented or offered, such as Multimedia Games' Ringy Dingy Reels®, Jambalaya Jackpot®, Meltdown®, Queen of the Desert®, and Texas Tornado®, with respective paytables and volatilities.

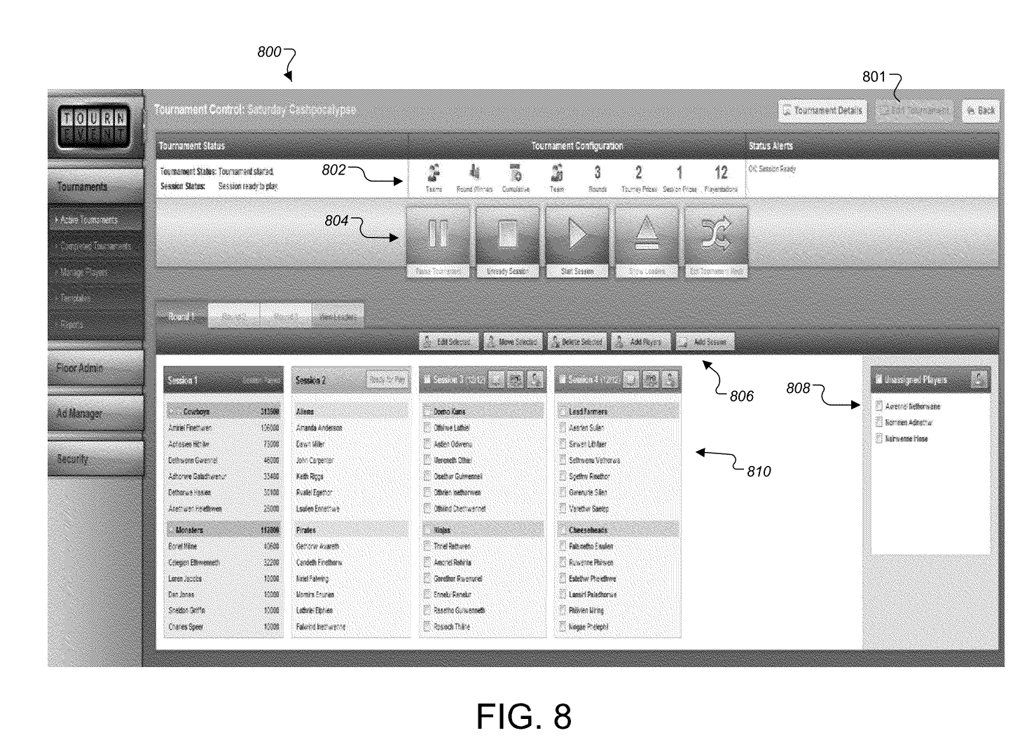

In the case where one of gaming machines 103 may operate as the control center server, the screenshot examples shown herein (e.g. FIG. 8 et seq.) may be displayed on one of the displays, such as display 113 or 115, each of which or either may be implemented as touch screen displays. In order to access the control center server operability, a user (operator) may be required to insert an authorized user card in card reader 119 and enter a password such as may be prompted on display 117. Upon identification of an authorized user, gaming machine 103 may display a menu on display 113 providing options for initiating or programming in-revenue or out-of-revenue operating modes and may further display a virtual keyboard on display 115 which may be used to enter data into respective fields shown on display 113. Additionally, in the case where one of gaming machines 103 may operate as the convertible server, all or a portion of gaming machines 103 may store the applicable programming so that in the event that an initially designated master gaming machine becomes inoperable, one of the other gaming machines 103 may, either automatically or according to a designated priority or manually, be designated to assume the control center server operations.

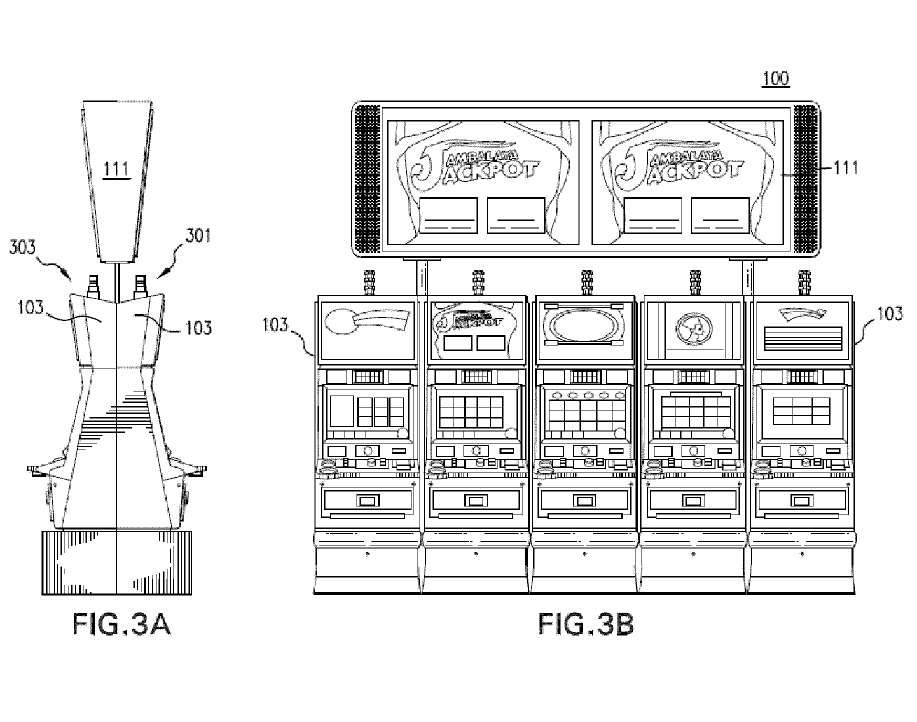

Referring to FIGS. 3A and 3B, a side and front view, respectively, of an example implementation of convertible in-revenue and out-of-revenue gaming system 100 is shown with two back-to-back sets 301, 303 of gaming machines 103 (which may be referred to as a bank or a pair of banks) with respective game themes, such as during an in-revenue gaming operating mode, and connected to a pair of back-to-back overhead displays 111 (showing an example game theme advertising banner) in accordance with one or more embodiments. As shown in FIG. 3A, pairs of back-to-back overhead displays 111 may be installed as a single unit with a casing that may be wider at the top than the bottom and the overhead displays may be slanted to adjust the viewing angle. While the overhead displays 111 may be fixed in relation to the casing, another embodiment may include a swivel attachment of each of overhead displays 111 along a horizontal axis enabling adjustment of the viewing angle of each display 111 with relation to the swivel attached to the respective display and the casing. For example, the swivel attachments may be secured to the bottom of the casing and the respective overhead display 111; and, tightening screws may be implemented either together with the swivel attachments or separately to fix the angle of the plane of each overhead display 111.

Referring to FIG. 4A, an example front view of convertible gaming machine 103 is shown with embedded camera 401, e.g. a conventional IP-video camera, operable to capture video feed of a player at the gaming machine and transfer the video feed to an area in one of the gaming machine displays, such as display 113, 115, or 117, one or more other gaming machines' displays and/or overhead display 111. In the example, display 117 is shown with an example tournament advertising banner in accordance with one or more embodiments.

Referring to FIG. 4A, example gaming machine 103 is shown including top glass display 113, middle display 117, primary display 115, and lower display 402 and user interface 405 (including button deck, printer 403, and card reader 119) wherein an in-revenue or out-of-revenue wagering game may be initiated by a player (such as by pressing the ‘Play’ button or by making a wager (selecting a number of lines and credits/line) and pressing the ‘Play’ button), a game processor may obtain a random or pseudo-random game outcome (such as by operating a random number generator (RNG) or by requesting a game outcome from the server, e.g. central determination or game, which may use an RNG to make a determination and forward to the game processor). The game processor for gaming machine 103 may instruct one or more displays to display a game presentation (such as spinning the reels in a reel-based game) in accordance with the game outcome, and the processor may pay winning game outcomes by incrementing the credit meter in accordance with the paytable (plus increment any additional amounts in the event of triggering a mystery bonus or other feature bonus).

Top glass display 113 may comprise a programmable portion of a separate display (such as an LCD, LED, TFT, etc. display), or glass, painted, etched, etc. presenting information related to the primary game or theme, such as a display of the paytable associated with the primary game and indicating the awards payable on the various winning primary game outcomes. Display 117 (such as an LCD, LED, TFT, etc. display) may be used to display alternative games (such as a bingo, lottery, card, mini-reel or other wagering game) or other feeds presented through the network, such as advertisements, where the alternative games may or may not require separate wagers or consideration, such as player points accumulated in a player account by a player.

Primary display 115 may display a primary game, such as the displayed Jambalaya Jackpot® reel game, and further display additional information such as lines wagered upon (“Lines”), bet per line (“Bet per Line”), total bet (“Total Bet”), credits on the gaming machine (“Credits”), and any winnings paid following a game play (which may include primary, feature, and community game play) (“Paid”). Display 402 may comprise a portion of display 115 or a separate display (such as an LCD, LED, TFT, etc. display) and display information, such as the player's status, player points, and/or enrollment in any group play (e.g. tournaments or competitions). User interface 405 generally includes a button deck for entering the selected number of lines the player wishes to wager upon, the number of credits per line plus a side bet, and to initiate play of the primary game. User interface 405 may also include card reader 119 for receiving a player card and transmitting player information over a network, and may include bill acceptor and printer 403 for receiving currency including tickets and printing tickets when a player desires to cash out from the gaming machine.

Referring to FIG. 4A, gaming machine 103, such as a Multimedia Games Jambalaya Jackpot® gaming machine, is shown, which may by example be connectable as shown in FIGS. 1-3B and have a set of mechanical or video reels displayed by display 115; video camera 401; player interface 405; and, an internally connected game processor. The gaming machine 103 may further include memory with a set of pre-loaded games (e.g. at least one primary in-revenue game for individual play such as the Jambalaya Jackpot® game and at least one group play game such as a tournament or competition game, and perhaps one or more interactive or non-interactive bonus games. The game process may be mounted on a printed circuit board with ports connecting to various sub-assemblies housed in or about the gaming machine cabinet in accordance with one or more embodiments of the invention. While gaming machine 103 is shown as an upright gaming machine cabinet style, various cabinet styles may be utilized, including a slant top cabinet style and a bar top cabinet style (where the cabinet may be part of a bar/table top and/or housed therein).

Each reel displayed by or through display 115 includes a series of symbols visible in a display area; for example, in the case of mechanical reels, a portion of each reel is visible in a display area through a window or panel. With the reels in a stationary position, the symbols visible in the display may be viewed as an array of symbols. During a wagering game, such as may be initiated by a player, the reels may be spun about an axle or simulated to spin under the control of a game processor which may randomly or pseudo-randomly determine the game outcome (or obtain the game outcome from a central determination or game server) and cause the reels to stop in accordance with the determined game outcome. Alternatively, the game processor may cause the reels to stop at random or pseudo-random stop positions and then analyze the displayed symbols to identify the outcome for the play.

One or more paylines, combinations, or patterns of the symbols including those visible through the display area may be correlated to a game result payable in accordance with a paytable, such as may be displayed on display 113. The reel display area may thereby be used to display the game result to one or more patrons standing in front of gaming machine 103. While example gaming machine 103 includes a set of five reels, various numbers of reels may be selected or utilized in an implementation of one or more embodiments, such as one, two, three, four, five, six, or seven reels, and so forth. In fact, the wagering game may not include reels, and may alternatively display, for example, a video card game (e.g. poker, blackjack), bingo, keno, or roulette. Panel dividers or frames may be painted, etched, virtualized, etc. onto the display area to provide a separate viewable area or window for each reel. The windows may serve to focus attention to the visible portion of the reels and, in the case of mechanical reels, to overlay reel dividers and/or the space between reels.

Alternatively to painting, etching, etc. onto the display area of the window or panel, display 115 may include a panel, such as a flat panel LCD or LED display, which may overlay the display area and be programmed to display an opaque frame image except over the display area (which may be transparent or translucent) during an operating mode when either the primary or group play game are operational, depending upon the selected design. In such case, the panel may be instructed by the game processor to display a bonus or feature game that may be triggered randomly or pseudo-randomly through an RNG, by a threshold count, by a countdown, or by the appearance of one or more special symbols (any of which may be triggers operable through programming executed by the game processor or a network-connected external server), and, may be programmed to enable player interactivity, such as requiring a player to select a displayed button or press an area of a touch sensitive panel overlaying an item, in order to cause the game to perform additional steps and provide one or more bonus or feature game outcomes and awards to the player.

Additionally, in one or more embodiments, the reels may be implemented using flexible reel strips, such as FOLED (flexible organic LED) reel strips, wherein one or more symbols may be programmed dynamically to vary the symbol and/or its appearance, either within a game or enabling conversion from a first game to a second game (i.e. in-revenue individual game to group play game and vice-a-versa). Additionally one or more display panels may be implemented to present each reel virtually. In the case of virtual displays of the reels, the symbols may be fixed or animated on each of the simulated reels. Also, overlapping display panels may be implemented to generate video or display effects over reels; for example, display 115 may be implemented to include transmissive (e.g. Aruze or WMS transmissive display panels) or transparent (e.g. Bally® transparent display panels) panels configured to display visual effects together with a set of reels (mechanical or virtual) under the control of the game processor during the operation of an in-revenue or out-of-revenue wagering game. In the case of virtual reels, the virtual reels may be recessed a distance from the front surface of the display area and segregated by dividers similar to dividers separating mechanical reels, which may provide a spatial characteristic (e.g. a PureDepth® display panel).

In one or more embodiments, the game processor operating the wagering game and controlling game lighting and effects in many instances is implemented as a microprocessor, such as an Intel Pentium® or Core® microprocessor, on a printed circuit board including one or more memory devices positioned within gaming machine 103. In alternative implementations, the game processor may be remote from gaming machine 103, such as on a server network connected to gaming machine 103 (e.g. gaming network 100, FIG. 1), in which case the game operation as described herein may be accomplished through network communications to control the display of the game on gaming machine 103 including the audio, visual, and game effects. It should be noted here that any terms indicating relative position used in this disclosure and the accompanying claims such as “front,” “rear,” “lateral,” “back,” and “top,” for example, are used with reference to the operating position of gaming machine 103 shown in FIG. 4A.

Referring to FIG. 4B, an example control structure 400 of gaming machine 103 is shown in accordance with one or more embodiments of the present invention. Game processor (CPU) 411 may comprise a conventional microprocessor, such as an Intel Pentium® or Core® microprocessor, mounted on a printed circuit board with supporting ports, drivers, memory, and coding to communicate with and control gaming machine operations, such as through the execution of coding stored in memory 413 including one or more individual wagering games 414 and one or more group play games (e.g. tournaments, competitions) 415. Game processor 411 connects to user interface 417 such that a player may enter input information and game processor 411 may respond according to its programming, such as to apply a wager and initiate execution of a game. Game processor 411 also may connect to a network, such as a casino server network (which may be implemented over one or more site locations) which may include host, remote game play, central determination, progressive gaming, player tracking, and accounting server functionality, through network controller 419 to enable network monitoring and sharing of data and information between respective of the servers in the network and gaming machine 103. Game processor 411 may also connect to various devices within and about the gaming machine including A/V system 421, reel assembly 423, and reel lighting assembly 425 through respective controllers, such as one or more video controllers 431, audio controllers 433, motor drive circuit controller 435, and light controller 437. In the case where the reels are implemented using a video display, reel assembly 423 and reel lighting assembly 425 may be modified or eliminated depending upon the desired configuration; for example, in one or more embodiments, it may be desirable to use reel lighting assembly 425 to amplify or provide various light effects in conjunction with a video reel display during game play, alternatively this functionality may be absorbed into the video display coding and presentation.

Generally, activity at gaming machine 103 may be initiated by a player inserting currency and/or a player card into a bill acceptor and card reader, respectively. Upon insertion, a signal is sent to game processor 411. In the case of the insertion of a player card, the card reader transmits card information which is directed through network controller 419 to a player tracking server connected to the network. Player data is transmitted to gaming machine 103, and, responsive to the data, game processor 411 may execute coding causing player data and a display (and possibly an audio) command to be transmitted to one of the video and/or audio controllers instructing the controllers to display player information on a respective display and possibly issue an audio greeting through one or more respective speakers. Concurrently, the bill acceptor sends a signal to game processor 411 which may include an identification of the currency that has been read, and game processor 411 in accordance with its coding may convert the currency amount to credits and transmit a store and display signal to a credit meter and its associated display (“Credits”). Once credits have been associated with the credit meter, the player may (for a reel-type game) select the number of paylines and credits per line that the player wishes to wager, whereupon game processor 411, in accordance with its coding, receives the wager information from user interface 417, transmits accounting and display information to the payline (“Lines”), credits per payline (“Bet per Line”), and total bet (“Total Bet”) meters and displays, transmits an update to the credit meter and display (“Credits”) deducting the amount of the total bet, and initiates the wagering game.

In the case of Class III gaming devices, when a game is initiated, a random number generator (RNG) is operated by game processor 411 to determine the game outcome. Commonly, game processor 411 is positioned within gaming machine 103 and configured to manage the operation of the gaming machine components, such as shown in FIG. 4B; however, the game processor may be either onboard or external to a gaming device (such as an electronic tablet (e.g. Apple® iPad® or gaming specific tablet), personal data assistant (PDA), cellular telephone (e.g. Blackberry® or Apple® iPhone®), surface table (e.g. Microsoft®/IGT touch sensitive gaming surface table) played by a player. Therefore, when the player places a wager and initiates play of the game through user interface 417 of the gaming device, the game processor may be onboard or remotely located such as within a network gaming server. In the latter case, an onboard microprocessor, controller, or digital signal processor may execute coding to transmit the wager and game request information through the network and the remote game processor may operate an RNG to determine the game outcome. In one or more embodiments, coding may be implemented and stored in memory 413, game memory 414, and group game memory 415, executable by game processor 411 to control the primary and feature game execution and to control associated electro-mechanical devices, such as reel lighting, speakers, and reels through respective video, audio, reel drive motor controllers, and lighting controller 437.

Program coding may be stored to execute and/or integrate gaming device operation with a tournament or competition, such as described herein, where a selected gaming machine 103 from a bank may be designated as control center server 101. For example, each gaming machine 103 of a bank may include coding executable by the designated host game processor to initiate and operate a tournament or competition game and also include coding to respond as a client gaming machine on the bank responsive to a primary controller. One of the gaming devices 103 may be designated as the primary controller responsible for converting operating modes of the selected banks of gaming machines 103, operating tournaments or competitions, and controlling content display on one or more displays, such as overhead display 111 and/or respective displays 113 (FIG. 5). In the case that the primary controller becomes unavailable, a second gaming machine may be designated as the backup primary controller and a rule of succession may be coded into each of gaming machines 103 of a respective bank. Each of the gaming devices may include monitoring coding executable on an ongoing periodic basis to ascertain which gaming device is the active primary controller during a given time period. Alternatively, the primary controller may be responsible to execute periodic polling of each of gaming machines 103 of the respective bank; and, in the event that the backup primary controller does not receive a poll within a designated period, the backup primary controller may commence operation as primary controller, commence polling operations, and commence execution of coding to randomly determine when to initiate the associated tournament game.

In one or more alternate embodiments, gaming machine 103 may have multiple games pre-loaded including a primary game (generally operational for in-revenue individual play) and a group play (tournament or competition) game, wherein either game may be operable by the game processor (depending on the setting or operating mode as may be controlled by control center server 101 through network commands) by executing respective of the game codes stored in memory. By example, the primary game may initially be operable for in-revenue individual play; the group play game may be initiated by a command from control center server 101 whereby gaming machine 103 may be converted from in-revenue individual play to group play (which may be in-revenue or out-of-revenue depending on the game rules and associated programming).

Once initiated, the group play game may be displayed on one of the displays operable by gaming machine 103, such as display 113 or 115 (reel display area), where a video representation of the group play game may be presented by either replacing or overlaying primary game display content. For example, if display 115 includes mechanical reels, display 115 may also include an overlaying panel (such as a flat panel display) which may be changed from a transparent mode during primary (or alternatively, group play) game operation to an opaque mode during group play (or alternatively, primary) game operation by instructions from the game processor instructing display 115 to mask the mechanical reels and display a video game associated with the group play (such as a reel-based game, video card game (e.g. poker or blackjack), bingo, keno, roulette or other wagering-type game). In the case where display 115 comprises two or more displays with or without mechanical reels, one or both displays may be used separately or together to display video content for the primary game and the group play game (for example, special effects or symbols may be rendered through an overlaying display while the underlying display displays the reels of the primary game or the field (or surface) of the group play game, depending upon which game is being shown or played).

Referring to FIG. 5, an example embodiment of convertible in-revenue and out-of-revenue game system 100 is shown with a bank of gaming machines 103 in a team tournament mode (which may be operable either in out-of-revenue or in-revenue modes) and with overhead display 111 showing an example real-time team leaderboard 601 and team video feed 603 in accordance with one or more embodiments wherein players at each of the gaming machines 103 compete in designated teams by playing their respective gaming machine 103 and accumulating a total award based on their play, which is used in providing a team score. In the example, each of gaming machines 103 are operating the same game as shown on display 115 and team leaderboard 601 is displayed on display 113 as well as on overhead display 111. The team tournament functionality described herein is a software upgrade of the tournament system described in the parent application, and uses the same software architecture, database architecture, network architecture, and hardware, with upgraded software design and database design to accommodate the team registration and tracking described herein. Overhead display 111 also displays team video feed 603, which here shows an image of one player but is configurable to show a team video feed as will be further described below. In the example shown, the video image displays the player, the player's name, and the player's team position in the competition (4th place as reflected by the ‘4’ displayed adjacent the player's image). Team leaderboard 601 includes the first five player's position, name, and accumulated point total. Team leaderboard 601 may be updated in real-time to show current positions and accumulated point totals of the respective teams and the individual players within the teams. The left-hand depicted column of data in team leaderboard 601 shows the team rankings, and the right-hand depicted column of data may show individual player rankings by total player score, or player rankings arranged in team ranking order as depicted in the example screen. While the depicted leaderboard shows lists of teams and players with their scores, this is not limiting and other embodiments include other depictions of the tournament team ranking status as further described below. Additionally, team leaderboard 601 may sequentially display standings of each of the teams, such as by cycling through all the team positions from first through the total number of participating teams. On each of gaming machines 103, display 115 may be personalized to show the top teams' positions while also showing the name of the player playing the respective gaming machine displayed as a header and the player's name, team, position and accumulated points highlighted on the leaderboard. In the example, the name of the respective player, team, position, and points may be circled on the respective display 113 so that the player at that gaming machine 103 may readily identify their ranking. In the case where the respective player is not in the top five, then the player's name, position, and accumulated points may be appended to the bottom of the displayed leaderboard on display 113 of that player's gaming machine 103.

In one or more embodiments, video feed may be delivered to each of displays 113 during an event to show video feeds of each of the participating teams, which may cycle through individual players such as by cycling every five seconds to rotate real-time or quasi-real-time images of the players, and/or to show a video feed of all players on the team simultaneously.

In one or more embodiments, the player video feeds and the team leaderboard may be broadcast to wireless devices, such as cellular phones. For example, a gaming facility or operator may maintain a website server and website, enabling individuals to dial-in or login to the website to receive audio-visual broadcasts of events occurring within the facility. The website server may receive updates through the network of various events that may be occurring simultaneously and update web pages associated with the website, enabling visitors to the website to view streaming and fixed content. The website may be maintained through a controlled-access intranet or broadly accessible internet service. In the case of controlled-access, each patron of a gaming facility may be provided a temporary username and password, such as may be provided during a patron's stay at a resort associated with the gaming facility. Patrons may thereby use their remote wireless device to enroll in a gaming event and pay an entry fee, monitor their time to attend the gaming event, and monitor their position within a gaming event in the case where there is more than one session or round associated with the gaming event.

Additionally, players enrolled in events may receive notifications, such as an automated phone call or text message, to advise the player of the time to attend the event, to advise the player of a player's position change within the event, or to advise the player of a delay in the event. Players may, for example, request notification at the time of enrollment or thereafter by using an identifying process, such as entering a username and password, to connect to a server and database with event and player information. Such notifications may also occur through a display and/or speaker at a gaming machine 103 being operated by a player, for example, if the player has requested a notification concerning an event and the player has a player card inserted in a gaming machine. The event server or the website server may query the player tracking server if the player's card is identified as connected to a gaming machine 103, identify the gaming machine 103, and transmit an instruction to the gaming machine 103 to display the notification on one of the associated displays. In another alternative, player cards with embedded identifiers (and enrolled cellular phones) may be identified through positioning systems within a gaming facility, such as GPS or related systems or proximity detection systems. Once an enrolled player is detected, a notification may be transmitted to a nearby display and/or speaker.

Similar features may be provided through an internet portal enabling visitors or patrons to access a website and similar restrictions may be implemented, if desired. For example, different levels of access may be provided to general visitors to the site versus current or past patrons to the gaming facility and/or associated resort.

In an alternate embodiment, patrons or visitors may dial-in to an audio-visual broadcast that may be accessed through their respective wireless or network connected devices, such as cellular phones or personal computing devices (e.g. personal computers, electronic pads, personal organizers, etc.). The content may be provided similar to a television broadcast wherein a schedule of events may be provided along with broadcast times. The broadcast network may be implemented as a closed circuit broadcast providing restricted access, or may be implemented as an open broadcast.

At the completion of the tournament event, a celebratory event may be displayed on overhead display 111 to name the winning team and present fanfare. The celebratory event may be displayed on one or more of displays 113, for example at the winning team members' gaming machines 103. In one or more embodiments, the streaming videos of the event may be recorded along with the leaderboard updates for the duration of the event, such that each of the participating players may be provided a personalized copy of the event, such as a DVD. In other alternatives, the event may be re-broadcast or accessible on-demand, such as through the gaming facility's website as described above.

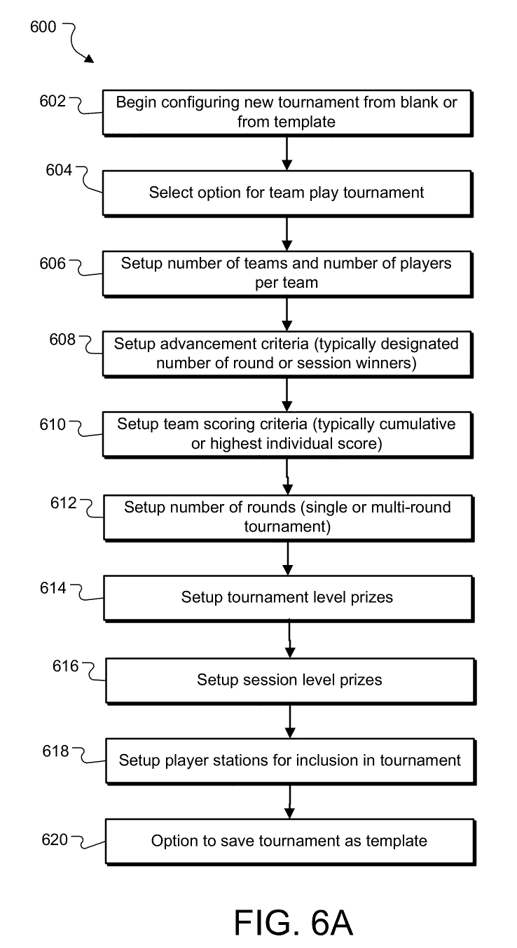

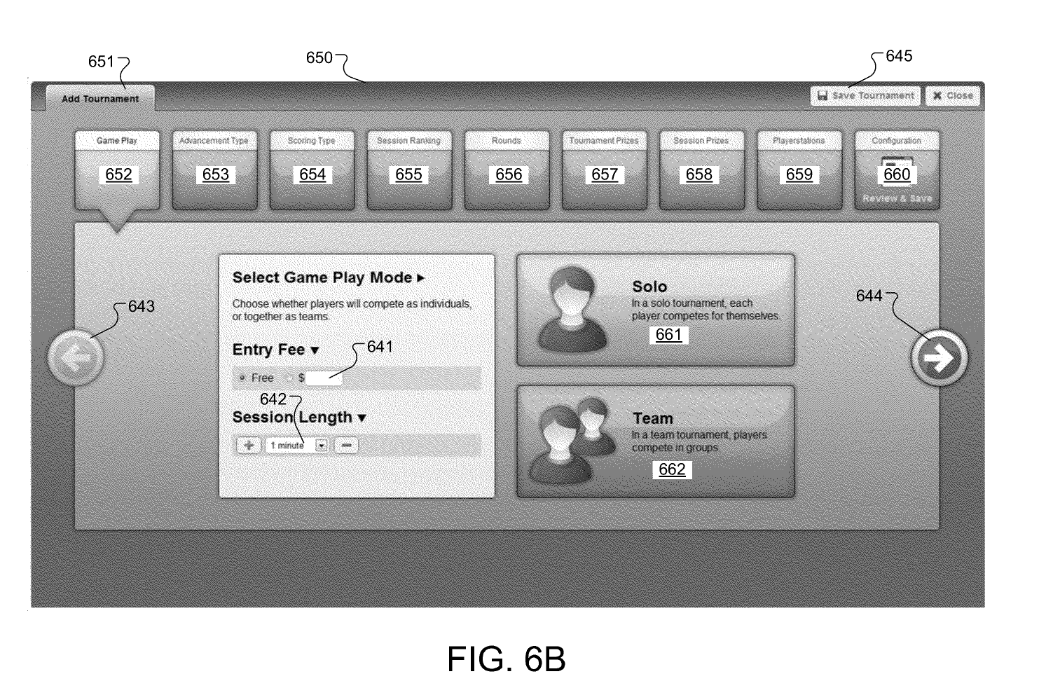

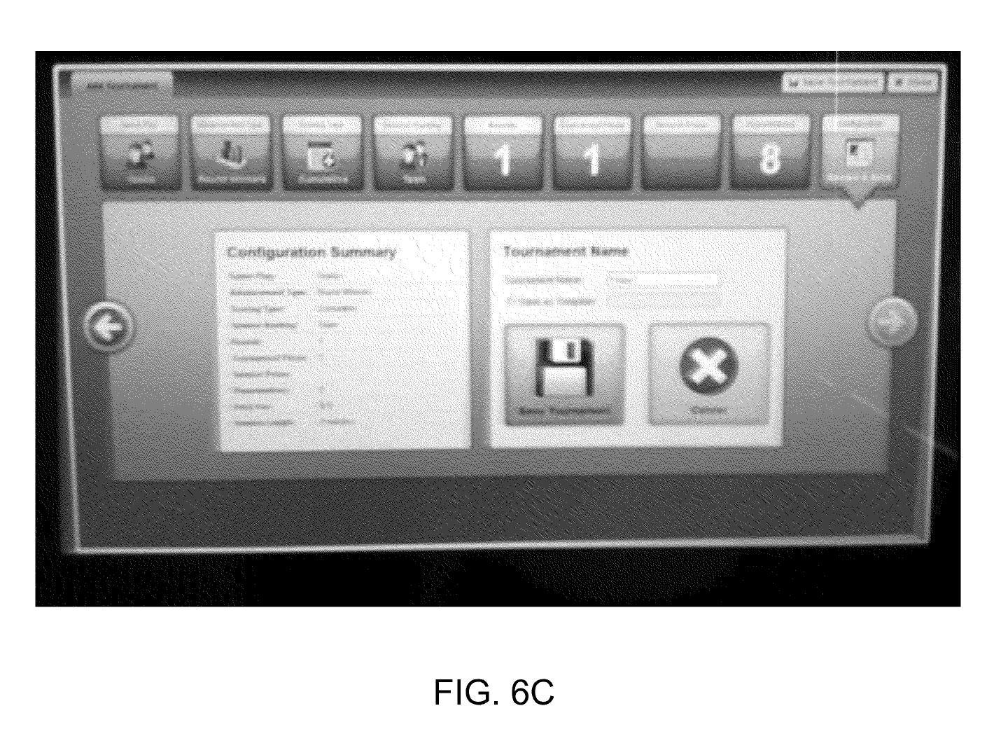

FIG. 6A is a flow chart of a process for setting up a new team tournament according to one embodiment. FIG. 6B is a screenshot diagram of an example tournament setup interface according to the embodiment of FIG. 6A. Generally, the team tournament feature of a TournEvent® system (interfaces shown in FIG. 6B, and FIG. 8) allows operators to organize their slot tournament players into teams and manage the advancement of those teams with a variety of templates throughout the tournament right on the tournament system user interface, thus eliminating the manual steps noted above. Referring to the process 600 shown in FIG. 6A, and to the tournament setup user interface 650 shown in FIG. 6B, the process begins at step 602 where the operator uses the interface to begin configuring a new tournament by accessing the add tournament tab 651, or opening an existing template to load the configuration of a previously created tournament setup. Next, at step 604, the operator configures the desired entry fee and the tournament session length using the depicted controls 641 and 642. The operator then selects an option for the present tournament to be a team play tournament by selecting button 662 (Since this is an upgrade to the parent application, and uses the same architecture and since single player tournaments are described in detail in the parent application, and so the option of selecting a solo tournament using button 661 will not be described in detail in the present application).

After selecting the solo or team gameplay mode in step 604, the process goes to step 606, in which the operator sets up the number of teams and the number of players desired per team. The order of steps for entering most of the depicted figuration data is not important, and of course the size and number of teams may be set later in the configuration process. Next at step 608, the operator configures the advancement type, that is, how the tournament will advance players, which is accessed in the depicted interface in FIG. 6B on tab 653. In a preferred embodiment, the advancement criteria are chosen from choices including how many players will be advanced at each stage of the tournament. For example the operator may setup single or multi-round tournaments advancing teams by round winner(s) or by session winner(s). Round winner(s) are tournaments where a set number of players with the highest scores will advance from the entire round. Session winner(s) are where a set number of session winners will advance from each session within a round.

Next at step 610, the operator sets the scoring criteria for the tournament, preferably using tab 654 in the depicted interface in FIG. 6B. This provides the option to configure whether the tournament advances teams by cumulative team score or by taking the highest individual player score from each team (max score or best ball). That is, if cumulative team score is selected and team x has 3 players and player 1 of team x has 15,000 points, player 2 of team x has 15,000 points and player 3 of team x has 20,000 points then team x will have 50,000 points. If max score is selected and team x has 3 players and player 1 of team x has 15,000 points, player 2 of team x has 15,000 points and player 3 of team x has 20,000 points then team x will have 20,000 points.

Next at step 612, the operator can set up the number of rounds of the tournament, and whether the tournament will be a single or multi-round tournament. Tab 656 of the interface in FIG. 6B allows the operator to setup team tournaments to display individual players on EGMs and the overhead signs as individual scores, or as team scores. If individual scores are displayed, each individual on a team will have their individual score displayed on their EGM and overhead sign(s). If a team score is displayed, all players on a team will display the team's overall rank on EGM and overhead sign(s). Further, if team score display is selected, then all players on team x that are currently in first place will have a red top screen indicating they are all in first place. Players on a team in 2^{nd} place will have green top screen, Players on a team in 3^{rd} will have purple top screen and all other players/teams will have blue top screen. Individual scores are expected to be good for large team tournaments while team score display would be good for small single session teams.

Next, at step 614, the operator can use the tournament prizes tab 657 to configure the tournament level prizes that will be awarded to the winning team, and any consolation prizes that may go to second or third place and other prizes that depend on the final results of the tournament. The next control is set at tab 658 in the depicted interface, where the operator sets session level prizes (step 616). These prizes are awarded based on the outcome of a particular session that is conducted within a round of the tournament. In a manner, these prizes may be considered consolation prizes for players who did well during a particular session and achieve either some high score or some other laudable goal within that session, but nevertheless did not advance to win the tournament. Of course, receiving a session level prize is typically not dependent on being left out of the final tournament level prizes, and often session level winners end up being the tournament level winners as well.

Next, at step 618, the operator uses the player stations tab 659 to set up which player stations, out of all the available and connected player stations, that may be employed for the tournament will actually be used. In many cases, this simply consists of the entire bank or group of machines around a single TournEvent group display. Other tournaments may use less then all of the machines of the group, or may use machines from multiple banks of tournament configured machines.

Finally, at step 620, the operator invokes tab 660 in FIG. 6B to open the configuration screen shown in FIG. 6C and may then review the configuration data entered, make any corrections, and save the data as an active tournament record to be used in the system. The configuration screen shown in FIG. 6C has an area on the labeled configuration summary displaying all the configuration data in one place. A summary of the configuration data is also displayed on the respective tabs across the top of the screen. This data gets filled in as the data is entered and the controller advances through the various tabs in the configuration process. Preferably this interface also provides the ability to save a template of all the configuration data, which may be opened to configure other tournaments and save time reentering all of the data that will be frequently reused. Thus FIG. 6C shows the option to “save tournament” in the box labeled “Tournament Name,” and provides an entry box for the tournament name, and under that there is a place for a template name. A checkbox above the save button controls whether the configuration data is saved as a template as well as a tournament. When using the interface depicted in FIGS. 6B-C, the operator uses forward and back buttons 644 and 643 to move among the various numbered tabs 652-660. While certain tournament configuration data has been described here, this is not limiting, and other embodiments may record other data to be used to control the operation of a tournament system. For example, scheduling data for the tournament may be recorded and may be used to automatically start the tournament, or to prompt a human operator at the control server 101 that it is time to start the tournament.

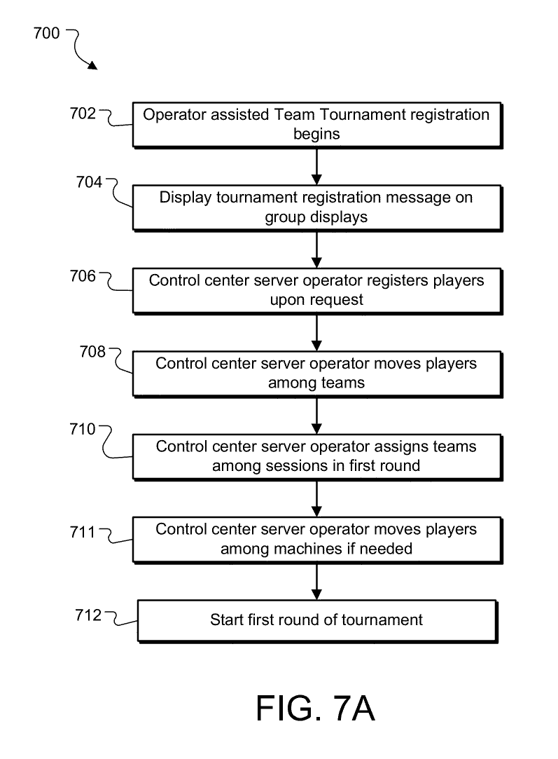

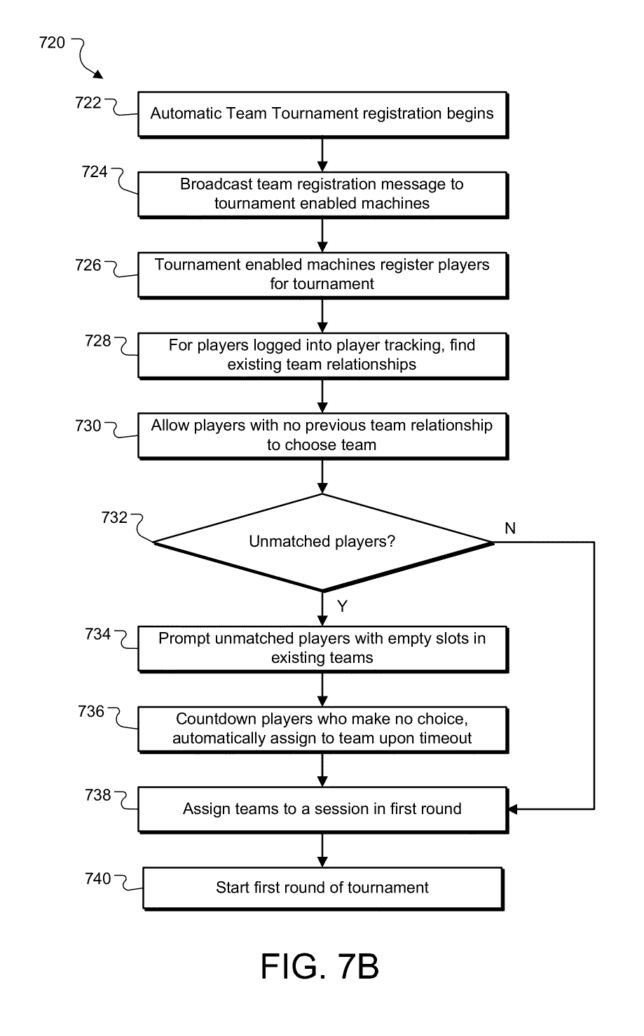

After the tournament is saved according to the process shown in FIG. 6A, the active tournament record can be brought up by an operator to register players and begin the tournament. Other embodiments may, of course, begin a tournament automatically. FIG. 7A is a flow chart of a team tournament registration process according to one embodiment. FIG. 7B is a flow chart of an alternative embodiment of an automated team tournament registration process. FIG. 8 is a screenshot diagram of an operator team tournament control interface according to one embodiment.

Referring to FIG. 7A, the depicted process 700 begins at step 702 after an operator has opened an active tournament record and navigated to the tournament control interface such as interface 800 shown in FIG. 8. Next, at step 704, the operator causes a tournament registration message to display on the overhead displays and other group displays chosen to advertise tournament availability to players in the area. Players can approach the operator, preferably at control center server 101, and indicate that they wish to be entered into the tournament. A group of participants may register as a team by requesting this from the operator. Typically, the registration process involves gathering the player's names and a desired team name, although this is not limiting and some embodiments may automatically assign team names or may use team names stored in the player tracking system associated with the player's membership card login. A preferred embodiment would also allow the first player to register for a team to select a team symbol from a list of available symbols. Other embodiments may just assign a symbol according to preselected criteria, or use no symbol.

For players who have not registered to be part of a team, the operator may assign the players to incomplete teams, or group single players together into new teams at step 708. This step preferably uses the tournament control interface 800 (FIG. 8) to allow the operator to move players among teams, and assign teams their places in the sessions within the first round of the tournament. Typically, a session uses all available gaming machines for the tournament in order to compete as many teams as possible against each other and advance the tournament as quickly as possible. The tournament data as shown in FIG. 8 includes four sessions for the first round of the tournament, as shown in the team session assignment area 810. The operator uses composer control buttons 806 to perform editing functions on the various team roster lists shown in area 810, and assign unassigned players to teams from the list of unassigned players in area 808. Preferably, only the first round is configured at this step because, of course, certain teams or players will be eliminated in the first round and therefore the second round session matchups must be determined by the operator after the first round outcome is known. As depicted, the team session assignment area 810 allows the operator to move individual players between teams or sessions, and to select and move an entire team at a time by selecting the box to the left of the team name shown in bolded letters.

Next, at step 711, the operator may move players among machines to accommodate location requests, such as players that want to be next to each other, with teams that want to be grouped together. Typically, players are assigned machines at random locations as they register for the tournament. However, this is not desired by some players, so step 711 provides the operator the ability to make adjustments.

Finally, at step 712, the operator may start the first round of the tournament when all players are ready, using the start session button in the button controls 804. Also shown in controls 804 is a show leaders button, which causes the overhead display to show the current leading teams of the tournament in progress. This will be further described below. Controls 804 also include a pause tournament button, which allows the tournament to be stopped and machines to be put back into revenue play until the tournament is resumed. To the right of this is an unready session button, which allows a single session to be paused. This is useful in some cases, for instance if players have not arrived to play in their designated session. In such case, the operator can make reassignments of players through the depicted interface in order to balance the teams and allow the tournament to go on without excessive disruption. Finally, the right-hand depicted button of button controls 804 is the exit tournament mode button, which ends the tournament mode and returns the machines back into individual in-revenue mode.

One advantage of the depicted team tournament control system is that it gives operators an easy and efficient way to run team tournaments without the hassle of manually exporting player data to spreadsheets and other 3rd party applications, in order to determine which players/teams will advance to subsequent rounds or win tournament. It also gives operators multiple ways to setup team tournaments thus allowing them to automate how they currently run their manual team tournaments. This automation makes the entire process more efficient and allows them to be able to run their tournaments faster and get their games back into in-revenue mode.

FIG. 7B shows a team term registration process 720 according to an alternative embodiment in which player registration is conducted automatically without intervention from a casino operator. The depicted process 720 starts at step 722 where the automatic team registration begins. This would typically occur when the system determines that a scheduled tournament is ready for registration. In other versions, players may select future tournaments from a menu and register for these without operator assistance as well.

At step 724 the system broadcasts a tournament registration message to all the enabled machines to indicate that they are available for tournament registration and to indicate to players who may currently be playing those machines in the in-revenue mode that the machines will soon be required for tournament play. This gives the player already playing on the machine the opportunity to register for the upcoming tournament to be conducted on the machine. In response to receiving the broadcast message, the gaming machine preferably displays a tournament registration message in the notification area, or on the top display that is not being used as part of an in-revenue game currently being played on the machine. Machines enabled for registration present a touchscreen button or other control allowing the player to enter a registration screen (step 726) where they may enter their name, enter a desired team name or choose from a list of team names already created for the selected tournament. Preferably, as soon as a player enters a team name, it is added to the list presented at every machine registry of players for the tournament, so that players who wish to be on the same team can easily find their team name without the risk of misspelling and having multiple versions of the team name being added to the tournament listing. A preferred version would also allow the first player of a team to select a team symbol from a list of symbols as well as a name, to further help players who wish to be on the same team to find their team.

At step 728, for versions that support team tracking through the player membership cards, the system checks for existing team relationships in the player tracking database. Such an existing relationship may be pre-populated into the tournament registration screen to save the player time entering their desired team name, while at the same time allowing them to use a different team from that stored in their player profile.

At step 730, those players who have registered singly, or registered with a group not large enough to fill an entire team, are allowed to choose a team out of the existing team names of the teams that are partially filled. After being presented with the option to choose a team, if players in the registration process have not chosen a team, and are therefore unmatched at step 732, the process goes to step 734 were it prompts any unmatched players to choose a team out of a list of teams with empty slots. At step 736, if a player has not made a choice after a countdown time period, the system assigns the player to a slot automatically. Preferably the system will try to balance the teams to an equal size. This may involve assigning unmatched players to the teams that are least full, and even breaking up small teams and reassigning the players. The system may also present the first player to register a team name to act as a team creator and designate whether the team is available for unmatched players to be added, or designate that all of their intended team members have not checked in yet and therefore that the system should not add unmatched players to the team. Next, at step 738, the system assigns the teams to their various sessions in the first tournament round, and starts the first round at step 740.

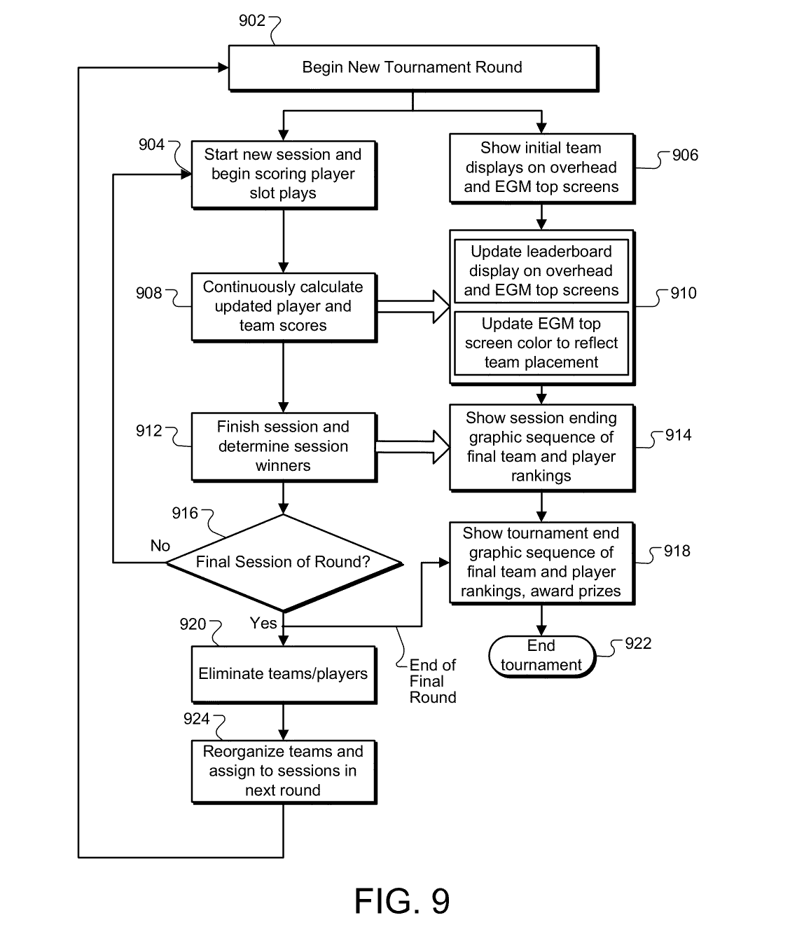

FIG. 9 is a flow chart of a process of conducting a team tournament according to one embodiment. Generally, throughout the tournament the team position and score is constantly displayed to player and spectators watching the tournament on the individual EGMs and overhead signs. This information is shown in real time and in an efficient way where players can see all tournament info without taking their eyes off the main game screen. As depicted in a flow chart, the right-hand steps 906, 910, 914, and 918 concern the leaderboard display on the overhead screen and the top screen of the various gaming machines. Example leaderboard screens are shown in FIGS. 10A-C.

Referring again to FIG. 9, the depicted process starts at step 902 where a new tournament begins after all players have been registered, for example as a result of that operator starting the first session through the interface shown in FIG. 8, or as a result of an automatically scheduled tournament beginning at the scheduled time. Next, at step 904, the process starts a new session of play including two more teams competing against each other for scores on the tournament slot machines. Along with the start of the session, preferably a graphic sequence including a countdown and other preparatory announcements is shown on the leaderboard, which may include an initial display showing teams and team members as depicted at step 906. The system continuously tracks each player and team scores at step 908, and when the initial individual and team scores from the first (or first few) slot machine results are calculated, the leaderboard displays are changed to a team leaderboard at step 910. This sets up the process by which the leaderboards are constantly updated with the individual and team scores as the tournament proceeds, unless the operator activates other features to display on the game board. For example, when the leading team changes, some announcements may be made on the leaderboard, along with a display of the leading teams' portraits and their team graphics, such as that shown in FIG. 10C.

When a tournament session ends, at step 912, the process uses team and individual scores to determine the session results and winners, which causes the leaderboard to show a session ending graphic sequence of the final team and player rankings in the session (step 914).

Next, at step 916, the process determines if the session just completed was the final session of the current tournament round. If not, the process returns to step 904 which starts the next session and round. If so, the process either proceeds to step 920 to do the end of round accounting, or go step 918 to finish the tournament process if the completed round was the final round in the tournament. In the case where there are more rounds of play, at step 920 the process eliminates teams and players according to the scoring method selected by the operator. Next, the process goes to step 924 where it reorganizes the teams according to the players and teams that have been eliminated, and assigns the teams to sessions in which they will compete in the next round. In a preferred embodiment, the session assignments are made by the operator of the depicted interface in FIG. 8. In other embodiments, the session assignments may be made automatically. After step 924, the process returns to step 902 and begins the next tournament round, which will include one or more sessions.

If the final round has been completed back at step 916, the process goes to step 918 where it shows a graphic sequence indicating the tournament is complete, and presents the final team and individual scores and rankings on the leaderboard. Step 918 also awards tournament level prizes and session level prizes that are due to the players. Preferably, session level prizes (those prizes accumulated by players or teams for winning a particular session) are indicated on the leaderboard by accumulating symbols next to the team or individual name that has won the session prize, but the prizes are awarded at the end of the tournament in order to keep the interest of players and teams who may be very far behind in the rankings focused on the end of tournament process, scores, and awards. The awards may be distributed automatically by the system, or handled by the operator, which is preferable in many jurisdictions where out-of-revenue prizes such as tournament prizes must be kept strictly separated from in-revenue game accounting systems such as the credit systems that store players' gaming credits in the casino.

FIG. 10A is a screenshot diagram of an example team leaderboard 601 according to one embodiment. On the left side is a listing of the team rankings 1001. Information included is their rank 1003, their team symbol 1004, the team name 1005, and the team point score 1006, which may be a cumulative score or highest individual player score as discussed above. On the right side of the team leaderboard is a list of the session player's rankings 1002. Information included is the individual player's rank 1007 based on the individual player's point score displayed to the right, the player's team symbol 1004, and the players screen name 1008. In the middle, along the bottom of the team leaderboard is a timer with the remaining session time 1009. Other embodiments rank players by their team ranking rather than their individual point score. In this fashion, the team tournament software quickly conveys team and individual rankings. This information would not be available during a manual team tournament as the individual player results would have to be collected and compiled.

FIG. 10B is a screenshot diagram of another example team leaderboard 601, divided into four team display areas represented by the depicted boxes. The box on the top left is labeled 1st place, indicating that it shows the team that is currently in first place in the tournament, identified by the team name shown at the top of the box. Inside the box are labeled squares that indicate a video display area for displaying video feeds of the team players, below which are their names and their team's scores. The displays can show all of the team players, or only selected top ranking players. There is a display for the current 2nd , 3rd , and 4th place teams as well. In the center on the bottom is a clock with the remaining session time. Throughout the tournament the individual picture in picture (PIP) screens of the team leaders are displayed on the team leaderboard. In this embodiment, the teams are displayed in order of their ranking. Other embodiments may display the teams in other orders, for instance in the order in which they finish. Although in this embodiment the leaders are all displayed at the same time, other embodiments may rotate the display of the team leaders individually or display only the top ranking team leaders.

Along with the leaderboard information described above, the top display on all EGMs display the team rankings with an actual live video feed of them playing, their name and their current position to further inform players of their status in the tournament. The present team tournament feature eliminates/minimizes problems associated with setting up and configuring manual team tournaments. With current team tournaments, players often cannot discern what team they are on, who their teammates are, or what place their team is until sometime after the end of the tournament. This time is dependent on how quickly the operator can manually crunch the numbers on which team(s) has accumulated the most points or has achieved the highest ranking and has won the tournament. The present team tournament feature does all of this in real time and the operator has the ability to export report(s) and to print them immediately during or after completion of the tournament. At the conclusion of the tournament, the PIP feed of each player on the winning team is displayed on the overhead sign and on each individual EGM.

FIG. 10C is a screen diagram of an example team video feed 603 according to another embodiment. In this embodiment, the leading team is displayed in the feed 603 after the session ends. The screen diagram shows a box in the center with 1^{st} place and the current first place team's name in it. Surrounding the 1^{st} place box are a collection of portrait or PIP video feeds for each player represented by the boxes labeled portrait or video. In a preferred embodiment the PIP feeds would have exiting video footage taken as the team was winning, but other options include a live feed. Although the entire team is being displayed at the same time in this example, other embodiments may display the players sequentially. Note that this display may be shown on command from the operator during the tournament, or may be automatically updated each time a different team takes the lead in the tournament.

FIG. 11 is a screenshot of two adjacent gaming cabinets showing team leaderboard displays for different teams. In this embodiment the team leaderboard on the left would have a red background indicating that the right player's team is in first place, and the team leaderboard on the right would have a green background indicating that the left player's team is in second place. Other embodiments may use different images in the background to indicate team ranking. The team leaderboards are also labeled along the top with the ranking of the respective team. Also on the bottom in the middle is a display showing the remaining time in the session. The team leaderboard is showing a player ranking list with the players' scores to the right of his name.

FIG. 12 is a diagram of a game screen feature in which player video is shown with an indication of the player's team. It is represented by a box labeled “Portrait or video of a player from EGM camera”. Although in this embodiment a video is used, other embodiments may use portraits of the players. In a preferred embodiment, the PIP video feed would show the current player, or may show a rotation showing the various members of the player's team or even the current points leader on the player's team. Under the PIP is the depicted player's rank, team name, and name.

Referring generally to the forgoing description and to the following claims, as used herein the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described example embodiments are intended to illustrate the principles of the invention, but not to limit the scope of the invention. Various other embodiments and modifications to these preferred embodiments may be made by those skilled in the art without departing from the scope of the present invention. The described embodiments illustrate the scope of the invention, but do not limit it.

1. A gaming machine tournament system including:
(a) a control center input system; and
(b) a control center server connected for communication with a group of gaming machines and adapted to:
(i) maintain a list of players registered for participation in a gaming machine team tournament;
(ii) maintain a list of teams registered for participation in the gaming machine team tournament, each team being associated with two or more of the players registered for participation in the gaming machine team tournament;
(iii) communicate display instructions to a display device associated with the group of gaming machines to cause the display device to display a leaderboard display continuously updated during the course of the gaming machine team tournament, the leaderboard display showing information about current team rankings in the gaming machine team tournament; and
(iv) calculate team tournament prizes for one or more winning teams participating in the gaming machine team tournament, and allocating the respective team tournament prize among the team members for the respective winning team.

2. The gaming machine tournament system of claim 1 wherein the display device is an overhead display device which is visible from two or more of the group of gaming machines.

3. The gaming machine tournament system of claim 2 wherein the control center server is also adapted to communicate the display instructions to a respective display device included at each of the group of gaming machines to cause the respective display device to display the leaderboard display continuously updated during the course of the gaming machine team tournament.

4. The gaming machine tournament system of claim 1 wherein the control center server is also adapted to communicate the display instructions to a respective display device included at each of the group of gaming machines to cause the respective display device to display the leaderboard display continuously updated during the course of the gaming machine team tournament.

5. The gaming machine tournament system of claim 1 wherein:
(a) the control center input system includes an operator input device; and
(b) the control center server is also adapted to register at least one of the players in response to registration information entered through the operator input device.

6. The gaming machine tournament system of claim 1 wherein the control center server is also adapted to register at least one of the players in response to registration information entered through a player interface system of one of the gaming machines.

7. The gaming machine tournament system of claim 1 wherein the control center server is also adapted to assign at least one of the players to a particular one of the gaming machines.

8. The gaming machine tournament system of claim 1 wherein the control center server is also adapted to cause a display device at one of the gaming machines to display one or more of the teams registered for participation in the gaming machine team tournament and to display a prompt for a player at the gaming machine to select one of the teams to be assigned to.

9. The gaming machine tournament system of claim 8 wherein the control center server is also adapted to assign the player at the gaming machine to one of the displayed teams in the event the player fails to select one of the teams within a predefined time limit after the prompt is displayed.

10. The gaming machine tournament system of claim 1 wherein the leaderboard display also shows information ranking at least some individual player tournament point totals.

11. The gaming machine tournament system of claim 1 wherein the leaderboard display includes a separate team display for two or more of the teams, each separate team display including an indication of the current rank of the team and including a portrait, player identifier symbol, or video sequence of one or more of the players assigned to that respective team.

12. The gaming machine tournament system of claim 1 wherein the control center server is also adapted to, in response to a player registration request for one of the players, access stored team association information which has previously been stored for that player, and assign that player to one of the teams based on the stored team association information.

13. A gaming machine tournament system including:
(a) a group of gaming machines, each of which being configurable for a play of a game included in a gaming machine team tournament; and
(b) a control center server having a control center input system and being connected for communication with each of the gaming machines in the group of gaming machines, the control center server being adapted to:
(i) maintain a list of players registered for participation in the gaming machine team tournament;
(ii) maintain a list of teams registered for participation in the gaming machine team tournament, each team being associated with two or more of the players registered for participation in the gaming machine team tournament;
(iii) communicate display instructions to a display device associated with the group of gaming machines to cause the display device to produce a leaderboard display continuously updated during the course of the gaming machine team tournament, the leaderboard display showing information about current team rankings in the gaming machine team tournament; and
(iv) calculate team tournament prizes for one or more winning teams participating in the gaming machine team tournament, and allocating the respective team tournament prize among the team members for the respective winning team.

14. The gaming machine tournament system of claim 13 wherein the control center server is also adapted to communicate the display instructions to a respective display device included at each of the group of gaming machines to cause the respective display device to display the leaderboard display continuously updated during the course of the gaming machine team tournament.

15. The gaming machine tournament system of claim 13 wherein:
(a) the control center input system includes an operator input device; and
(b) the control center server is also adapted to register at least one of the players in response to registration information entered through the operator input device.

16. The gaming machine tournament system of claim 13 wherein the control center server is also adapted to register at least one of the players in response to registration information entered through a player interface system of one of the gaming machines.

17. The gaming machine tournament system of claim 13 wherein the control center server is also adapted to assign at least one of the players to a particular one of the gaming machines.

18. The gaming machine tournament system of claim 13 wherein the control center server is also adapted to cause a display device at one of the gaming machines to display one or more of the teams registered for participation in the gaming machine team tournament and to display a prompt for a player at the gaming machine to select one of the teams to be assigned to.

19. The gaming machine tournament system of claim 13 wherein the leaderboard display also shows information ranking at least some individual player tournament point totals.

20. The gaming machine tournament system of claim 13 wherein the leaderboard display includes a separate team display for two or more of the teams, each separate team display including an indication of the current rank of the team and including a portrait, player identifier symbol, or video sequence of one or more of the players assigned to that respective team.
